(19) United States
(12) Patent Application Publication
(10) Pub. No.: US 2014/0272078 A1
(43) Pub. Date: Sep. 18, 2014

(54) COFFEE PRESERVATION METHODS

(71) Applicant: Federico Bolanos, El Salvador (SV)

(72) Inventor: Federico Bolanos, El Salvador (SV)

(21) Appl. No.: 13/839,149

(22) Filed: Mar. 15, 2013

(51) Int. Cl. A23F 5/10; B65B 31/00

(52) U.S. Cl. CPC A23F 5/105; B65B 31/00
USPC 426/595; 53/403

(57) ABSTRACT

A method for preserving green coffee beans by storing or packaging the beans in a nitrogen-filled low-oxygen-permeability container with at least one oxygen absorbent or scavenger. A method for preserving roasted coffee beans by storing or packaging the beans in a nitrogen-filled container that can withstand the pressure of the carbon dioxide gas released by the coffee beans after roasting, the pressurized container may include at least one oxygen absorbent or scavenger. And a method for establishing a vintage coffee system.

### FIELD OF THE DISCLOSURE

Embodiments of the present disclosure relate to, among other things, methods for preserving coffee and, in particular, to a method for preserving green coffee beans and a method for preserving roasted coffee, as well as a method for establishing a vintage coffee system.

### BACKGROUND OF THE DISCLOSURE

The present invention relates generally to a method of storing and packaging green coffee beans and a method of storing and packaging roasted coffee to allow for long-term preservation of the coffee while maintaining the freshness and quality without compromising the aroma and taste of the coffee.

Coffee trees produce coffee cherries, which are picked when ripe. To gain access to the green coffee bean inside the coffee cherry, coffee cherries are processed using a natural or wet method. Under the natural method, the entire coffee cherry is cleaned and placed to dry, usually in the sun. Alternatively, drying machines can be used. As one example, as the coffee cherries dry, they are raked or turned to ensure even drying of the entire cherry.

Once the coffee cherries are dried, all of the outer layers of the dried coffee cherries are removed in one step, usually by a hulling machine. The coffee beans are then sorted, graded, and bagged. Under the wet method, the fruit covering the coffee bean is removed before the bean is dried. One manner of removing the fruit from the coffee bean entails using a depulper machine that removes the skin and pulp of the coffee cherry by mechanically scrubbing the cherry. After the pulp has been removed, the coffee beans still have a layer of mucilage clinging to it, so they are passed to tanks to remove that mucilage by means of fermentation, either by immersing the bean in water or through dry fermentation. After the mucilage has been broken down and removed from the beans, the beans are washed.

Another way of processing coffee cherries under a wet method involves using a machine to remove the mucilage after the depulper machine has removed the skin and pulp, instead of fermenting and washing the beans in tanks. Once the skin, pulp and mucilage is removed, the bean is surrounded by two layers, a silver skin and parchment. The beans are then dried to lower their humidity level to the usually desired level of 10% to 12%.

It will be apparent to a person skilled in the art that various methods of drying can be used and the present inventors intended to apply any of those methods. During the drying process the parchment layer of the beans becomes solid and forms a crust covering the bean. After coffee beans have reached the desired humidity level, the coffee is stored for a period of time, usually 30 to 45 days, and then the parchment layer is removed through a hulling process, usually machine assisted. Once hulled, the coffee bean is referred to as “green coffee.” The coffee beans are then sorted, graded, stored, and bagged.

Next, the green coffee beans are placed in large containers or bags for sale or export. Most coffee is shipped, stored, and distributed as green coffee beans.

Green coffee beans are then roasted in roasting machines. Coffee is roasted at sufficient time and temperature to reach a desired result. As a result of the roasting process, the roasted coffee beans release carbon dioxide (CO₂).

Green coffee beans have an approximate shelf-life of up to a year when maintained in proper conditions. Current methods of storing green coffee beans, however, do not allow the preservation of coffee beans for more than one season. Accordingly, green coffee from the prior year's crop is considered to have expired and is generally not sold. In contrast, roasted coffee beans are freshest the same day they are roasted and quickly degrade, within a few days after roasting.

The prior known methods or processes for storing or packaging coffee, both green and roasted, maintain the freshness and quality of the bean for a limited period of time. There remains a need for effective methods for preserving green and roasted coffee without compromising the taste of the coffee and while maximizing the shelf-life of the coffee beans.

Green coffee beans are typically stored in burlap bags or inside plastic bags placed inside the burlap bags. No additional processing is applied at the site of origin of the coffee and before shipping. Typically, no extraordinary measures are taken for packaging and storing green coffee. MiCafeto coffee company in Japan has vacuum-packed green coffee beans in small portions and stored them at approximately 64 degrees Fahrenheit, but only after the coffee beans arrive at warehouses in Japan. The MiCafeto method is applied months after the green coffee beans have been harvested, dried, and shipped to Japan, and the beans are not subjected to any preservation method prior to arriving at the warehouses in Japan.

Each of these prior known methods presents disadvantages to preserving the green coffee beans while maintaining their freshness and quality. Packaging coffee in burlap bags allows oxygen and moisture to leave and enter the coffee bean, which can affect the moisture content of the bean and its quality. Packaging coffee in plastic bags inside burlap bags may reduce the amount of external humidity and oxygen that enter the bag but a significant amount of oxygen within the bag will cause deterioration of the coffee beans. The MiCafeto method is also not applied at the site of origin of the coffee beans, allowing months to pass before applying any preservation method to the green coffee beans.

There remains a need for a method for storing or packaging green coffee beans that preserves the freshness and quality of the bean.

Oxygen also degrades roasted coffee. One known method for storing roasted coffee involves storing the coffee in opaque bags with a one-way valve that allows CO₂ to escape, and prevents oxygen from entering, the bag. A second known method involves packaging roasted coffee beans in a container that can withstand the pressure of the CO₂ gases that are released by roasted coffee beans after roasting. For example, MiCafeto has stored roasted coffee beans in champagne and/or PET bottles. MiCafeto has also first filled the champagne and/or PET bottles with nitrogen gas to keep oxygen within the container at less than 1%, prior to filling the container with roasted coffee beans.

Although the use of opaque bags with one-way valves may help to preserve the coffee, this method increases shelf-life only marginally while compromising the quality and flavor of the coffee. The MiCafeto method improves the shelf-life of the coffee with little compromise to the quality and flavor of the coffee. Yet, substantial degradation may occur before this method is applied. There remains a need for a coffee preservation method for roasted coffee beans that minimizes the amount of oxygen exposure to the coffee while maintaining the freshness and quality of the bean.

### SUMMARY OF THE DISCLOSURE

Some embodiments of the present disclosure address the problems of known prior storage and packaging methods for green and roasted coffee beans. An object of certain embodiments of the invention is to provide a green coffee bean preservation method that can be employed at any point between drying the green coffee bean and roasting the green coffee bean to preserve the freshness and quality of the green coffee.

Another object of some embodiments of the invention is to provide a roasted coffee bean preservation method that preserves the roasted coffee bean with little to no negative effect on the freshness and quality of the bean as well as the flavor and aromas of the coffee.

Yet another object of some embodiments of the present invention is to utilize the green coffee bean preservation method and roasted coffee bean preservation method, alone or in combination, to create a vintage coffee system. The vintage coffee system is similar to the vintage system currently known for wines with the difference being that the flavors and aromas of the coffee remain nearly intact. While currently impractical for coffee due to the inability of known methods to preserve coffee for more than a current growing season, embodiments of the present invention enable coffee beans from various harvests, seasons, varietals, origins, estates, microlots, processes, and locations to be preserved for months or years.

An embodiment of the invention involves preserving green coffee beans by storing or packaging green coffee beans in a nitrogen-flushed, low-oxygen-permeability container that includes an oxygen-absorbent material or scavenger. The method for storing or packaging the green coffee beans involves employing a low-oxygen-permeability container to eliminate or significantly reduce the amount of oxygen that can enter the container after it is sealed; flushing the empty container with nitrogen; including an oxygen-absorbent material or scavenger in the low-oxygen-permeability container; filling the low-oxygen-permeability container with green coffee beans; and sealing the container. The low-oxygen-permeability container can be of any size and shape.

Oxygen-absorbent materials or scavengers are well-known and different kinds of oxygen absorbents or scavengers may be used, including, for example, Mitsubishi Ageless® oxygen absorber. The configuration, number, strength, and volume of oxygen absorbents or scavengers in the low-oxygen-permeability container should be tailored to the amount of green coffee beans stored in the container and the size of the container. For example, more oxygen aborbent or scavenger may be needed in a container that stores five pounds of green coffee beans than in a container that stores one pound. Embodiments of the present disclosure may be used any time after the green coffee beans are dried and before the green coffee beans are roasted.

Another embodiment involves preserving roasted coffee beans by storing or packaging roasted coffee beans in a nitrogen-flushed container that can withstand the pressure from the CO₂ released from the coffee beans after roasting. An oxygen scavenger may be included in the container to absorb oxygen remaining in the container to prevent or substantially reduce oxidation of the roasted coffee beans. Oxygen absorbers and/or scavengers are available in many different forms. For example, an oxygen scavenger can be sprayed in the container, glued to an interior wall or bottom of the container, mounted in a cap, or included as part of the container. The method for storing or packaging roasted coffee beans may include the steps of: flushing the container with nitrogen; including an oxygen absorbent or scavenger in the container; filling the container with roasted coffee beans; and sealing the container. The container may be similar to the shape and thickness of a champagne, wine, or PET bottle, although the present disclosure is not limited to these sizes and shapes of containers. The container can be of any suitable material, size, or shape. The roasted coffee bean preservation method can also be applied to roasted ground coffee.

Another embodiment of the present invention utilizes the green coffee bean preservation method and roasted coffee bean preservation method, alone or in combination, to preserve green and roasted coffee beans for months or years while maintaining their freshness and quality to create a vintage coffee system. The vintage coffee system disclosed is akin to a vintage wine system in which coffee from various harvesting seasons, varietals, origins, estates, microlots, processes, and locations can be preserved for later consumption.

### BRIEF DESCRIPTION OF THE DRAWINGS

FIG. 1 is a flow chart depicting the processing of coffee beans from field to cup.

FIGS. 2a-d are flowcharts depicting different embodiments of the present disclosure employing a green coffee preservation method of the present disclosure.

FIG. 3 is a flowchart depicting an embodiment of the present disclosure employing a roasted coffee preservation method of the present disclosure.

### DETAILED DESCRIPTION

Reference will now be made in detail to the embodiments of the present disclosure described below and illustrated in the accompanying drawings. Wherever possible, the same reference numbers will be used throughout the drawings to refer to same or like parts.

Although the present disclosure is described with reference to illustrative embodiments, it is not limited to these illustrative embodiments. Persons of ordinary skill in the art will appreciate that modifications and additional applications, embodiments, and substitution of equivalents all fall within the scope of the invention as claimed. Accordingly, the disclosure is not to be considered as limited by the foregoing or following descriptions.

Other features and advantages and potential uses of the present disclosure will become apparent to a person skilled in the art from the following description of the disclosure, which refers to the accompanying drawings.

The disclosed embodiments relate to preservation of green coffee beans and/or roasted coffee beans based on various storing or packaging methods. Another embodiment of the present invention relates to utilizing coffee preservation methods for green coffee beans and roasted coffee beans, alone or in combination, to create a vintage coffee system.

FIG. 1 depicts a known method of packaging and storing coffee beans. The coffee beans are grown 101; harvested 102; processed (wet or natural); dried 103; hulled, sorted, graded 104-105; and packaged 106. Prior known methods package green coffee beans in large (50 to 132 lb.) inner polyethylene bags which are placed in outer burlap bags. The coffee is stored 106 in this manner until it is ready to be shipped 107. The coffee is shipped in the same packaging and stored 109 at the destination until it is sold and distributed 109. Upon distribution, the coffee may be repackaged in smaller containers for delivery to roasting facilities, stores, or individual consumers 110. The green coffee is then roasted 111, repackaged 112, and further distributed 113. The packaging of the roasted coffee is typically in an opaque, UV resistant bag with a one-way gas valve. The one-way gas valve permits the out-gassing of CO₂ from the roasted coffee beans while not permitting the admission of oxygen into the bag.

Storage or packaging of green coffee beans by known methods, such as that depicted in FIG. 1, can have an adverse effect on the preservation of the green coffee beans, which can impact the shelf-life and quality of the coffee. The green coffee bean preservation method of this disclosure may increase the shelf-life of the green coffee bean while preserving the freshness and quality of the coffee.

A method of an embodiment of the invention involves flushing a container with nitrogen or another inert gas. The gas may be an inert gas or another gas that is safe for food contact and either does not react or reacts only minimally with the coffee beans. The container preferably has low-oxygen permeability to prevent or reduce the amount of oxygen that can permeate through the container.

In a further embodiment, the method involves placing an oxygen-absorbent material or scavenger within the container so that oxygen remaining in the container or oxygen that permeates through the container is absorbed. The configuration, number, size, and volume of oxygen-absorbent or scavenger may depend on the size of the container, the amount of green coffee in the container, the volume fraction of coffee to gas in the container, and the rate of oxygen absorption of the oxygen-absorbents or scavengers.

Alternatively, the low-oxygen-permeability container may include oxygen-absorbent properties. For example, one or more of the walls or edges of the low-oxygen-permeability container can be manufactured to include an oxygen-absorbent material or scavenger. As means of another example, an oxygen scavenger can be sprayed or glued to the interior of the container.

The container is preferably filled with dried green coffee beans and sealed. The order of performing the steps of placing an oxygen absorbent or scavenger within the container and filling the container is not critical.

In an alternative embodiment of the present disclosure, the container may be filled with green coffee in a nitrogen atmosphere to significantly reduce or eliminate the amount of oxygen in the container. Alternatively, the atmosphere may be another gas that displaces oxygen. The gas may be an inert gas or another gas that is safe for food contact and either does not react or reacts only minimally with the coffee beans. This embodiment may be appropriate for a mass-production operation given the capital cost involved with such a facility. Alternatively, the container can be filled using a machine that can pressurize the container, or in a pressurized room, to further reduce the partial pressure of oxygen in the container upon filling.

As shown in FIG. 2a, the green coffee preservation method of the present disclosure may be performed after the coffee beans are graded. In alternative embodiments of the present disclosure shown in FIGS. 2b through 2d, the preservation method may be performed at any point after the coffee beans are dried, and may be performed at multiple points in the processing of the coffee beans. For example, coffee producers can store and package green coffee beans using the disclosed green coffee bean preservation method after the beans are harvested and dried 205. Similarly, coffee importers can perform the green coffee bean preservation method before 226 or after 248 the beans are shipped. Coffee purchasers or roasters can also store or package green coffee beans using the green coffee bean preservation method to preserve green coffee beans until the beans are roasted 270.

The freshness and quality of roasted coffee beans is at its best immediately after roasting. As time passes and the beans are exposed to oxygen, the coffee beans become stale and the quality and taste of the coffee deteriorates rapidly. Roasted coffee beans are known to remain fresh for only a few days or weeks. Roasted coffee is known to have a shelf-life of up to one year but with severe deterioration of its freshness, taste and quality. Oxidation is one of the main agents responsible for this deterioration. The roasted coffee bean preservation method disclosed in this invention seeks to significantly reduce oxidation.

An embodiment of the present disclosure involves flushing a container with nitrogen or another inert gas. The gas may be an inert gas or another gas that is safe for food contact and either does not react or reacts only minimally with the coffee beans. The container must be strong enough to withstand the pressure of the CO₂ gas released by the coffee beans after roasting. Examples of suitable containers include glass or PET (polyethylene terephthalate) bottles, but the container can be of any suitable material, size, or shape.

In an embodiment of the present disclosure, the roasted coffee beans are stored in hermetically-sealed champagne bottles. The roasted coffee bean preservation method can also be applied to roasted ground coffee.

To absorb oxygen remaining in the container after filling, an oxygen-absorbent material or scavenger suitable for use in environments with CO₂ may be placed in the pressurized container. Alternatively, the container may already include oxygen-absorbents or scavengers suitable for use with CO₂. For example, one or more of the walls or edges of the container can be manufactured to include an oxygen-absorbent material or scavengers. Alternatively, an oxygen scavenger can be sprayed or glued to the interior of the container.

The container is then filled with roasted coffee beans and sealed. For the CO₂ released from the roasted coffee beans to quickly reach an equilibrium point, the volume fraction of the roasted beans to gas in the filled container is preferably in excess of 55%. More preferably, it is in excess of 60%. Even more preferably it may be in excess of 65%. The higher the volume fraction of coffee beans to gas at filling, the faster the outgassing of CO₂ reaches equilibrium, and the lower the residual amount of oxygen. In addition, the higher the volume fraction of coffee beans to gas in the filled container, the lower the concentration of the residual oxygen present in the filled container and the shorter the period of time that the residual oxygen exerts its initial partial pressure in the filled container.

In another embodiment of the present invention, the container is filled with roasted coffee beans in a nitrogen atmosphere to significantly further reduce or eliminate the amount of oxygen. The atmosphere can alternatively be filled with another gas with the purpose of significantly reducing the amount of oxygen in the room. The gas may be an inert gas or another gas that is safe for food contact and either does not react or reacts only minimally with the coffee beans. Alternatively, the container can be filled with a machine that can pressurize the container or in a pressurized room to further reduce the partial pressure of oxygen in the container.

The roasted coffee bean preservation method may be practiced with any size and shape pressurized container. Coffee beans vary in size and shape. Preferably, roasted coffee beans will be packaged in amounts of 16 grams, 24 grams, 32 grams, 64 grams, 192 grams, 227 grams, 336 grams, and 448 grams. For example, the method can be practiced using a single serving pressurized container filled with enough roasted coffee beans to prepare a single 8 ounce cup of coffee as is generally the case with a container filled with 16 grams of coffee.

The roasted coffee bean preservation method can be performed any time after the coffee beans are roasted as shown in 310 in FIG. 3. Preferably, the roasted coffee bean preservation method is performed immediately after the coffee beans are roasted to minimize oxidation.

A further embodiment involves using the green coffee bean preservation method and the roasted coffee bean preservation method, alone or in combination, to establish a vintage coffee system. Coffee can be preserved for months or years using the methods of the present disclosure. As a result, coffee beans from a particular harvest, location, varietal, processing method, or roast profile, can be preserved for later consumption without compromising the freshness and quality of the coffee.

A number of embodiments of the present invention have been described. Nevertheless, it will be understood that various modifications may be made without departing from the spirit and scope of the invention. Accordingly, it is understood that the invention is not limited to the specific illustrated embodiments.

What is claimed is:

1. A method for preserving green coffee beans comprising:
flushing a low-oxygen permeability container with a gas, wherein the gas is an inert gas safe for food contact, wherein the gas minimally reacts with green coffee beans;
including at least one oxygen absorbent in said container;
filling said container with green coffee beans; and
sealing said container.

2. The method claim 1, wherein the gas is nitrogen.

3. A method for preserving green coffee beans comprising:
flushing with a gas a low-oxygen permeability container having an oxygen absorbent membrane, wherein the gas is an inert gas safe for food contact and minimally reacts with green coffee beans;
filling the low-oxygen permeability container with green coffee beans; and
sealing the low-oxygen permeability container.

4. The method claim 3, wherein the gas is nitrogen.

5. A method for preserving green coffee beans comprising:
filling a low-oxygen permeability container with green coffee beans in a room filled with a gas other than oxygen, wherein the gas is an inert gas safe for food contact, wherein the gas minimally reacts with green coffee beans; and
sealing the low-oxygen permeability container.

6. The method claim 5, wherein the gas is nitrogen.

7. A method for preserving roasted coffee comprising:
flushing with a gas a container that is configured to withstand pressure of carbon dioxide released from roasted coffee, wherein the gas is an inert gas safe for food contact, wherein the gas minimally reacts with roasted coffee;
filling the container with roasted coffee; and
sealing the container.

8. The method claim 7, wherein the method further comprises the step of including at least one oxygen absorbent in the container.

9. The method claim 7, wherein the gas is nitrogen.

10. The method claim 7, wherein the method is performed within about 24 hours after roasting the roasted coffee.

11. The method claim 7, wherein the method is performed 24 hours or more after roasting the roasted coffee.

12. The method claim 7, wherein a volume fraction of gas to roasted coffee in the container is in excess of 53%.

13. The method claim 7, wherein the roasted coffee is ground.

14. The method claim 7, wherein the roasted coffee is coffee beans.

15. A method for preserving roasted coffee comprising:
flushing a container that is configured to withstand pressure of carbon dioxide released from roasted coffee and that includes an oxygen absorbent membrane, with a gas, wherein the gas is an inert gas safe for food contact, wherein the gas minimally reacts with roasted coffee;
filling the container with roasted coffee; and
sealing the container.

16. The method claim 15, wherein the gas is nitrogen.

17. The method claim 5, wherein the method is performed within 24 hours after roasting the roasted coffee beans.

18. The method claim 15, wherein the method is performed 24 hours or more after roasting the roasted coffee beans.

19. The method claim 15, wherein a volume fraction of gas to roasted coffee beans in the pressurized container is in excess of 53%.

20. The method claim 15, wherein the roasted coffee is ground.

21. The method claim 15, wherein the roasted coffee is coffee beans.

22. A method for preserving roasted coffee beans comprising:
filling a container that is configured to withstand pressure of carbon dioxide released from roasted coffee with roasted coffee in a room filled with a gas, wherein the gas is an inert gas safe for food contact, wherein the gas minimally reacts with roasted coffee bean;
sealing the container.

23. The method claim 17, wherein the gas is nitrogen.

24. The method claim 17, wherein the method is performed within 24 hours after roasting the roasted coffee beans.

25. The method claim 17, wherein the method is performed 24 hours or more after roasting the roasted coffee beans.

26. The method claim 17, wherein a volume fraction of gas to roasted coffee beans in the pressurized container is in excess of 53%.

27. The method claim 7, wherein the roasted coffee is ground.

28. The method claim 7, wherein the roasted coffee is coffee beans.

29. A sealed container comprising:
less than 1% oxygen;
an oxygen-absorbent material; and
coffee beans.

30. The sealed container of claim 29, wherein the coffee beans are green coffee beans.

31. The sealed container of claim 30, wherein the container has low-oxygen permeability.

32. The sealed container of claim 29, wherein the coffee beans are roasted coffee beans.

33. The sealed container of claim 32, wherein the container is configured to withstand pressure of carbon dioxide given off by roasted coffee.

34. The sealed container of claim 33, wherein the container is filled with about 227 grams of roasted coffee beans.

35. The sealed container of claim 33, wherein the container is filled with about 336 grams of roasted coffee beans.

36. The sealed container of claim 33, wherein the container is filled with about 448 grams of roasted coffee beans.

37. Coffee beans packaged in a sealed container, wherein the sealed container comprises:
less than 1% of oxygen; and
an oxygen-absorbent material.

38. The sealed container of claim 37, wherein the coffee beans are green coffee beans.

39. The sealed container of claim 38, wherein the container has low-oxygen permeability.

40. The sealed container of claim 37, wherein the coffee beans are roasted coffee beans.

41. The sealed container of claim 40, wherein the container is configured to withstand pressure of carbon dioxide.

42. The sealed container of claim 41, wherein the container is filled with about 227 grams of roasted coffee beans.

43. The sealed container of claim 41, wherein the container is filled with about 336 grams of roasted coffee beans.

44. The sealed container of claim 41, wherein the container is filled with about 448 grams of roasted coffee beans.
